(19) United States
(12) Patent Application Publication
(10) Pub. No.: US 2003/0110161 A1
(43) Pub. Date: Jun. 12, 2003

(54) METHOD, PRODUCT, AND APPARATUS FOR PROVIDING SEARCH RESULTS

(76) Inventor: Mr. Eric Schneider, University Heights, OH (US)

Correspondence Address: Eric, Schneider, 13944 Cedar Road #258, University Heights, OH, 44118, US

(21) Appl. No.: 09/542,166

(22) Filed: Apr. 4, 2000

Related U.S. Application Data
(60) Provisional application No. 60/127,813, filed on Apr. 5, 1999.

(51) Int. Cl. G06F 7/00

(52) U.S. Cl. 707/3

(57) ABSTRACT

### Abstract of Disclosure

A network access apparatus, servlet, applet, stand-alone executable program, command line of a device such as a phone browser, or user interface element such as a text box object or location field of a web browser, receives and parses a search request. When search results having one or more resource identifiers are generated, it is determined whether at least one network resource corresponding to the one or more resource identifiers can not be located. When it is determined that the at least one network resource corresponding to the one or more resource identifiers can not be located, search results are then modified and provided in response to the search request.

### Cross Reference to Related Applications

This application claims the benefit of the following patent application, which is hereby incorporated by reference: U.S. Provisional Application Ser. No. 60/127,813, filed April 5, 1999, by Schneider entitled "Method and system for displaying search results."

### Background of Invention

### Field of the Invention

This invention generally relates to searching for information, and more specifically relates to a method, product, and apparatus for providing search results.

### Description of the Related Art

The Internet is a vast computer network having many smaller networks that span the world. A network provides a distributed communicating system of computers that are interconnected by various electronic communication links and computer software protocols. Because of the Internet's distributed and open network architecture, it is possible to transfer data from one computer to any other computer worldwide. In 1991, the World-Wide-Web (WWW or Web) revolutionized the way information is managed and distributed.

The Web is based on the concept of hypertext and a transfer method known as Hypertext Transfer Protocol (HTTP) which is designed to run primarily over a Transmission Control Protocol/Internet Protocol (TCP/IP) connection that employs a standard Internet setup. A server computer may provide data and a client computer may display or process it. TCP may then convert messages into streams of packets at the source, then reassemble them back into messages at the destination. Internet Protocol (IP) handles addressing, seeing to it that packets are routed across multiple nodes and even across multiple networks with multiple standards. HTTP protocol permits client systems connected to the Internet to access independent and geographically scattered server systems also connected to the Internet.

HTTP provides a method for users to obtain data objects from various hosts acting as servers on the Internet. User requests for data objects are made by means of an HTTP request, such as a GET request. A GET request may include a GET request keyword, the full path of the data object, the name of the data object, and an HTTP protocol version, such as "HTTP/1.0". In the GET request shown below, a request is being made for the data object with a path name of "/example/" and a name of "file.html":

GET /example/file.html HTTP-Version

Processing of a GET request entails the establishing of a TCP/IP connection with the server named in the GET request and receipt from the server of the data object specified. After receiving and interpreting a request message, a server responds in the form of an HTTP RESPONSE message. Response messages begin with a status line comprising a protocol version followed by a numeric Status Code and an associated textual Reason Phrase. Space characters may separate these elements. An exemplary format of a status line is depicted below:

Status-Line=HTTP-Version Status-Code Reason-Phrase

The status line may begin with a protocol version and status code, (e.g., "HTTP/1.0 200"). The status code element may represent a three digit integer result code of the attempt to understand and satisfy a prior request message. The reason phrase gives a short textual description of the status code, and the first digit of the status code may define the class of response. Generally, there are five categories for the first digit. 1XX is an information response, and is not currently used. 2XX is a successful response, indicating that an action was successfully received, understood and accepted. 3XX is a redirection response, indicating that further action must be taken in order to complete the request. 4XX is a client error response. This indicates a bad syntax in the request. Finally, 5XX is a server error. This indicates that the server failed to fulfill an apparently valid request.

Web browsers, such as Microsoft Internet Explorer (MSIE) and Netscape Navigator provide graphical user interface (GUI) based client applications that implement the client side portion of the HTTP protocol. One format for information transfer is to create documents using Hypertext Markup Language (HTML). HTML pages are made up of standard text as well as formatting codes that indicate how the page should be displayed. The client side web browser reads these codes in order to display the page. A web page may be static and requires no variables to display information or link to other predetermined web pages. A web page is dynamic when arguments are passed which are either hidden in the web page or entered from a client browser to supply the necessary inputs displayed on the web page. Common Gateway Interface (CGI) is a standard for running external programs from a web server. CGI specifies how to pass arguments to the executing program as part of the HTTP server request. Commonly, a CGI script may take the name and value arguments from an input form of a first web page which can be used as a query to access a database server and generate an HTML web page with customized data results as output that is passed back to the client browser for display.

While an incredible amount of information is available on the millions of web pages provided on the World Wide Web, some of this information is not appropriate for all users. In particular, although children can be exposed to a vast number of educational and entertaining web pages, many other web pages include adult content, which is not appropriate for access by children.

One method that is used to control access to these adult web pages is to require an access code to view or download particular web pages. Typically, this access code is obtained by providing some identification, often in the form of a credit card number. The obvious drawbacks of this method are such a system will invariably deny or inhibit access to many adults as well as children because many adults do not want to, or may not be able to, provide a credit card number, and the system is not fool-proof because children may obtain access to credit cards, whether theirs or their parents'.

Several services are available to parents and educators, which provide another method for preventing access to web pages having adult content. These services provide software programs that contain a list of forbidden URLs. Service providers compile the list by searching the World Wide Web for web pages having objectionable material. When a URL is inputted that appears on the forbidden list or "deny list," the program causes a message to be displayed indicating that access to that web page is forbidden. Although this method works well for denying access to web pages which are on the forbidden list, because thousands of web pages are being created and changed every day, it is simply impossible to provide an up-to-date list of every web page containing adult content. Therefore, these systems often allow children access to web pages that contain adult content but have not yet been added to the forbidden list. Though there are many methods in the art for content filtering, there are no known such methods that prevent the filtering of links on the fly in real-time that may be provided in search results wherein such links may further access undesirable content.

Internet search engines are used by portal web sites such as "excite.com", "altavista.com", "snap.com", "infoseek.com", and "lycos.com", etc., to provide directory and search services. Access to searchable databases of network resources is relied upon daily by millions of users. When a user provides a search request to a client system, a query is sent to a server connected to the Internet and processed to retrieve Uniform Resource Locators (URLs) that correspond to the search request. Web page results are typically generated and displayed to the client in a batch of hyperlinks. Because of the vast amount of information traversed to create a searchable database, search results reflect URL information that may be weeks or months old. In turn, displayed results may reflect duplications of the same URL or URLs that may have changed since first collected. Steps have been taken to improve search and retrieval techniques by removing duplicate URLs from query results and providing functions for sorting such results by relevance with additional links to accessing related URLs.

U.S. Patent 5,855,020 issued on December 29, 1998 by Kirsch, entitled, "Web scan process" discloses an update and purge algorithm for periodically updating or removing obsolete or invalid resource locators from a search database. Though this algorithm helps to reduce the number of non-working, inaccessible, unavailable, or dead links from a database, there is still the possibility that URLs have been updated or no longer exist and remain inaccessible, unavailable, or not working at the time of the search request, allowing for such dead links to be returned as part of results from the search request. The display or inclusion of these dead links does not provide useful information and continues to be an inconvenience to the user.

### Summary of Invention

The present invention assures the quality and accuracy of search results including mitigating the possibility of providing non retrievable information. The present invention utilizes the delay between loading advertising and returning search results to improve the quality of such results. An efficient method of updating information while verifying link accessibility and availability is provided. The present invention may employ distributed caching to minimize network bandwidth for determining link availability, and distinguish unavailable or dead links with an indicator when search results are displayed. The invention provides content filtering in real time assuring that children are not exposed to adult content.

In general, in accordance with the present invention a method includes the steps of generating search results having one or more resource identifiers, determining whether at least one network resource corresponding to the one or more resource identifiers can not be located, and modifying the search results and providing the modified search results when it is determined that the at least one network resource corresponding to the one or more resource identifiers can not be located.

In accordance with one aspect of the present invention a method includes the steps of generating search results having one or more hyperlinks, determining whether at least one hyperlink of the one or more hyperlinks is dead, and modifying the search results and providing the modified search results when it is determined that the at least one hyperlink of the one or more hyperlinks is dead.

In accordance with another aspect of the present invention a method for providing search results to a user from a search request includes the steps of receiving the search request, retrieving search results from the search request, determining whether the search results include any unavailable links, providing the search results to the user in response to determining that the search results do not include any unavailable links, modifying at least one unavailable link from the search results in response to determining that the search results do include at least one unavailable link, and providing the modified search results to the user.

In accordance with yet additional aspects of the present invention, a system which implements substantially the same functionality in substantially the same manner as the methods described above is provided.

In accordance with other additional aspects of the present invention, a computer-readable medium that includes computer-executable instructions may be used to perform substantially the same methods as those described above is provided.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### Brief Description of Drawings

Fig. 1a is a block diagram of an exemplary distributed computer system in accordance with the present invention.

Fig. 1b is a diagram depicting the location field or web page search request used in a conventional web browser.

Fig. 1c is a block diagram illustrating exemplary information records stored in memory in accordance with the present invention.

Fig. 1d presents an exemplary table in accordance with the present invention illustrating a data structure of a resource identifier status cache.

Fig. 2 is a flowchart illustrating the steps performed by a prior art system for displaying search results.

Fig. 3a is a flowchart illustrating the steps performed for modifying retrieved search results in accordance with the present invention.

Fig. 3b is a flowchart illustrating the steps performed for combining advertising retrieval while filtering retrieved search results in accordance with the present invention.

Fig. 4 is a flowchart illustrating the steps performed for generating modified search results and scheduling information updates.

Fig. 5a is a flowchart illustrating the steps performed for determining link availability with a link cache having only unavailable or dead links.

Fig. 5b is a flowchart illustrating the steps performed for removal of unavailable links in accordance with the present invention.

Fig. 5c is a flowchart illustrating the steps performed for highlighting unavailable links in accordance with the present invention.

Fig. 6 is a flowchart illustrating the steps performed for determining resource identifier status with a link cache having both available and dead links.

Fig. 7 is a flowchart illustrating the steps performed for filtering links in real time based on content criteria.

### Detailed Description

The present invention will now be described with reference to the drawings, wherein like reference numerals are used to refer to like elements throughout.

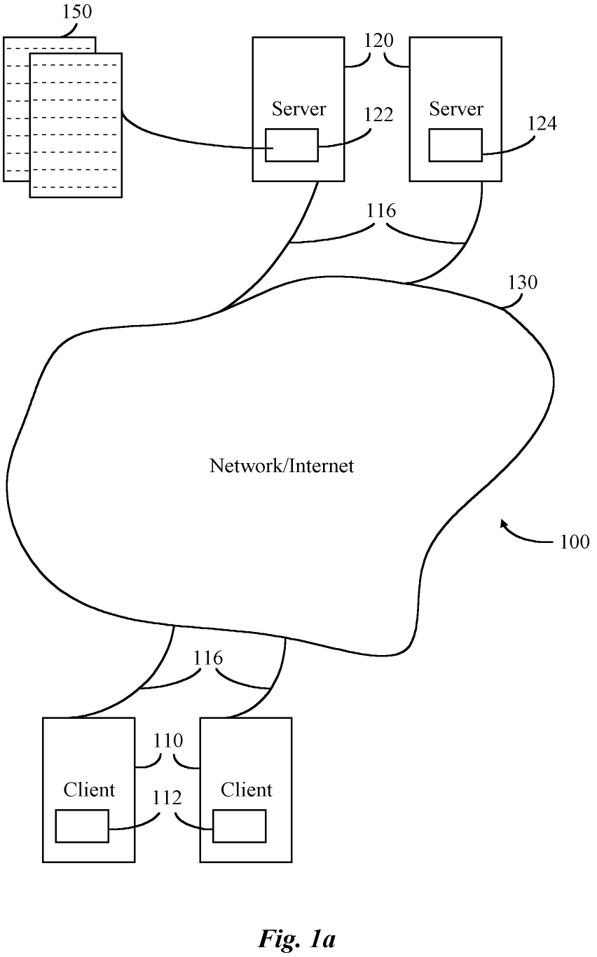

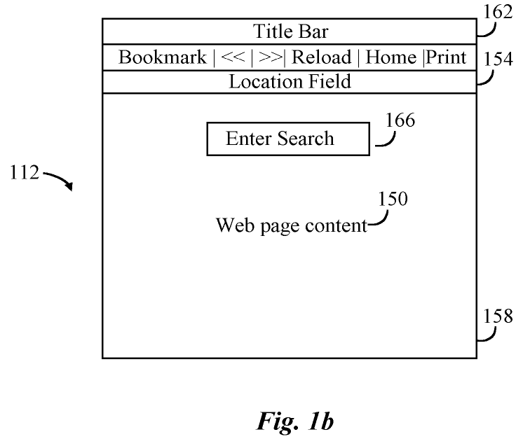

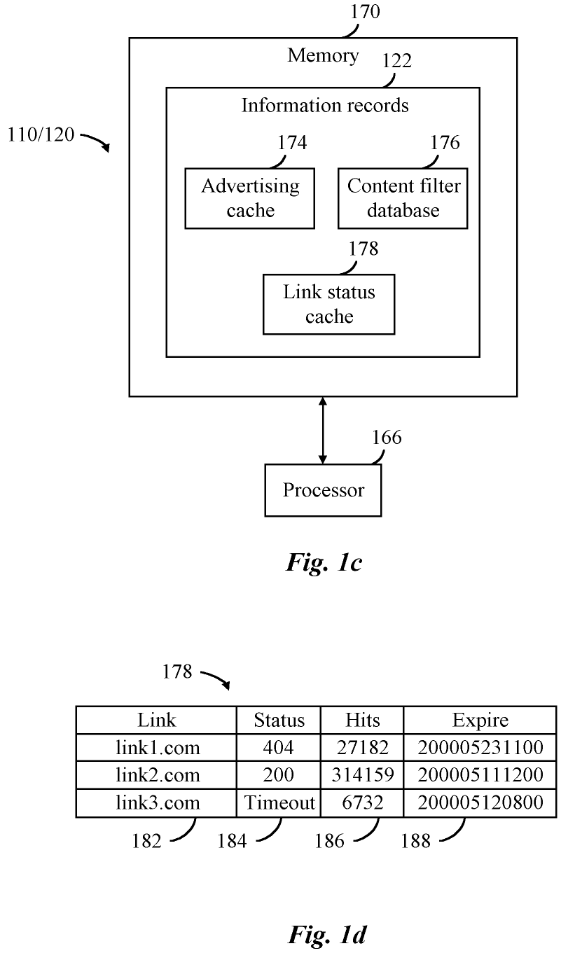

Fig. 1a illustrates an exemplary system for providing a distributed computer system 100 in accordance with one aspect of the present invention and includes client computers or any network access apparatus 110 connected to server computers 120 via a network 130. The network 130 may use Internet communications protocols (IP) to allow the clients 110 to communicate with the servers 120. The network access apparatus 110 may include a modem or like transceiver to communicate with the electronic network 130. The modem may communicate with the electronic network 130 via a line 116 such as a telephone line, an ISDN line, a coaxial line, a cable television line, a fiber optic line, or a computer network line. Alternatively, the modem may wirelessly communicate with the electronic network 130. The electronic network 130 may provide an on-line service, an Internet service provider, a local area network service, a wide area network service, a cable television service, a wireless data service, an intranet, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems. It is noted that the network access apparatus 110 may have a variety of forms, including but not limited to, a general purpose computer, a network computer, a network television, an internet television, a set top box, a web-enabled telephone, an internet appliance, a portable wireless device, a television receiver, a game player, a video recorder, and/or an audio component, for example.

Each client 110 typically includes one or more processors, memories, and input/output devices. An input device may be any suitable device for the user to give input to client computer 110, for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye tracking device, or any MIDI device may also be used. A display device could be any suitable output device, such as a display screen, text-to-speech converter, printer, plotter, fax, television set, or audio player. Although the input device is typically separate from the display device, they could be combined; for example: a display with an integrated touchscreen, a display with an integrated keyboard, or a speech-recognition unit combined with a text-to-speech converter.

The servers 120 may be similarly configured. However, in many instances server sites 120 include many computers, perhaps connected by a separate private network. In fact, the network 130 may include hundreds of thousands of individual networks of computers. Although the client computers 110 are shown separate from the server computers 120, it should be understood that a single computer may perform the client and server roles. Those skilled in the art will appreciate that the computer environment 100 shown in Fig. 1a is intended to be merely illustrative. The present invention may also be practiced in other computing environments. For example, the present invention may be practiced in multiple processor environments wherein the client computer includes multiple processors. Moreover, the client computer need not include all of the input/output devices as discussed above and may also include additional input/output devices. Those skilled in the art will appreciate that the present invention may also be practiced via Intranets and more generally in distributed environments in which a client computer requests resources from a server computer.

During operation of the distributed system 100, users of the clients 110 may desire to access information records 122 stored by the servers 120 while utilizing, for example, the Web. Furthermore, such server systems 120 may also include one or more search engines having one or more databases 124. The records of information 122 can be in the form of Web pages 150. The pages 150 can be data records including as content plain textual information, or more complex digitally encoded multimedia content, such as software programs, graphics, audio signals, videos, and so forth. It should be understood that although this description focuses on locating information on the World-Wide-Web, the system can also be used for locating information via other wide or local area networks (WANs and LANs), or information stored in a single computer using other communications protocols.

The clients 110 may execute Web browser programs 112, such as Netscape Navigator or MSIE to locate the pages or records 150. The browser programs 112 enable users to enter addresses of specific Web pages 150 to be retrieved. Typically, the address of a Web page is specified as a Uniform Resource Identifier (URI) or more specifically as a URL. In addition, when a page has been retrieved, the browser programs 112 may provide access to other pages or records by "clicking" on hyperlinks (or links) to previously retrieved Web pages. Such links may provide an automated way to enter the URL of another page, and to retrieve that page.

Fig. 1b more specifically illustrates an exemplary selection of common operative components of a web browser program 112. The web browser 112 enables a user to access a particular web page 150 by typing the URL for the web page 150 in the location field 154. The web page 150 content corresponding to the URL in the location field 154 may be displayed within the client area of the web browser display window 158, for example. Title information from the web page 150 may be displayed in the title bar 162 of the web browser 112. Web page 150 content may further include a user interface element such as that of an input text box 162 for inputting search requests.

Fig. 1c illustrates a block diagram of a processor 166 coupled to a storage device such as memory 170 in a client 110 or server 120 computing system. Stored in memory are information records 122 having combinations of the following content such as lists, files, and databases. Such records can include; an advertising cache 174, a content filter database 176, and a link cache/resource identifier status cache 178. These information records are further introduced and discussed in more detail throughout the disclosure of this invention.

Fig. 1d illustrates an exemplary data structure for storing data in a resource identifier status cache such as a link cache 178. Such data includes the link or network resource identifier such as URL 182, the status of the link 184, the number of URL requests 186, and an expiration time 188 to remove a record from the link cache 178.

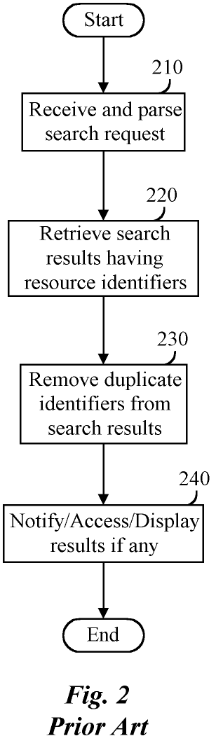

Fig. 2 is a top-level flowchart illustrating the steps of an exemplary prior art system for returning search results. A network access apparatus 110, servlet, applet, stand-alone executable program, command line of a device such as a phone browser, or user interface element such as a text box object or location field 154 of a web browser 112, receives and parses a search request in step 210. The search request is passed to a server system 120 (e.g., search engine having a database 124) and search results having resource identifiers are retrieved in step 220. The search request is generally passed as a query to access a database stored on the server system 120 and the retrieved resource identifiers may represent network resources in the form of URLs or hyperlinks. Before search results are passed back to the client system 110, duplicate resource identifiers are removed in step 230 from the search results. The removal of duplicate identifiers becomes particularly useful when the search request is sent to multiple search engines for querying. After removal of duplicate identifiers in step 230 then results, if any, are then notified, accessed, and/or displayed in step 240.

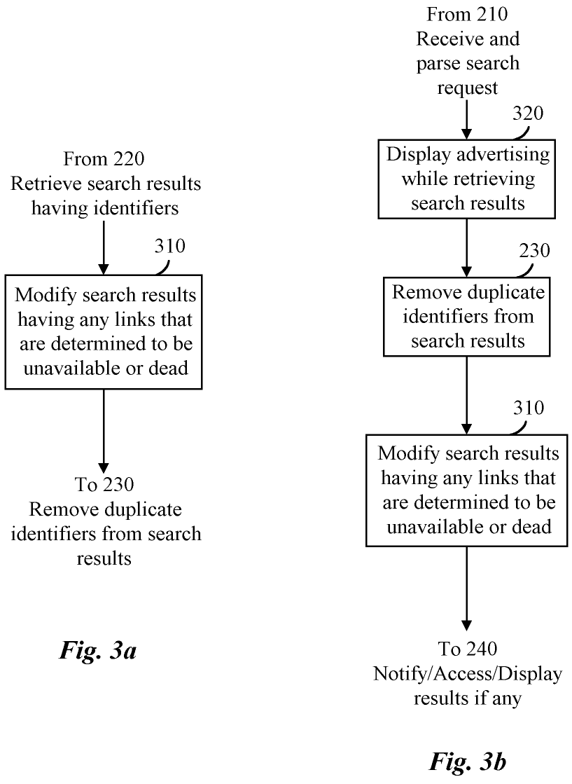

Fig. 3a is a top-level flowchart that illustrates how search results may be modified from a search request in accordance with the present invention for the processing of search results. When search results having resource identifiers are retrieved in step 220, all network resources that can not be located corresponding to resource identifiers from search results such as unavailable or dead links are modified in step 310, first, before duplicate resource identifiers from search results are removed in step 230.

Fig. 3b is a flowchart illustrating an alternative aspect of the present invention. When a search request is received and parsed in step 210, context sensitive advertising is retrieved in step 320 from an advertising cache 174 when the search request is passed to a server system 120 and such advertising is displayed creating a time delay to be utilized while search results are still being retrieved in step 220. Duplicate identifiers from search results may then be removed in step 230, first, before identifiers from search results are determined to be unavailable and/or modified in step 310. After all resource identifiers/links are modified in step 310, the results, if any, may then be notified, accessed, and/or displayed in step 240.

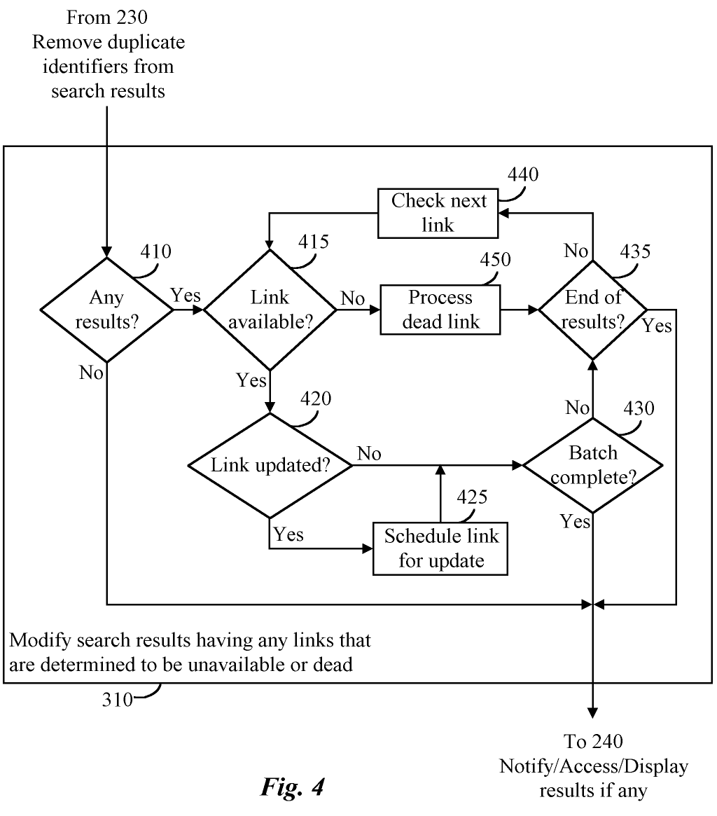

Fig. 4 is a flowchart that illustrates a process for modifying unavailable or dead links from search results (step 310). After duplicate identifiers from search results are removed in step 230 and it is determined in step 410 that there are no search results, then information may be displayed in step 240 to the client to indicate that there are no results. When it is determined in step 410 that there is at least one result, availability for each hyperlink may be determined in step 415 before generating a web page of results. When the current link is determined in step 415 to be available (e.g., a network resource corresponding to the link can be located) and the content of the link is determined in step 420 to be updated then the link may be scheduled in step 425 for update retrieval. However, if the link is determined in step 415 to be available and the link is determined in step 420 to not be updated or scheduled in step 425 for an update, a determination is made in step 430 whether a batch of results is complete. When the batch is determined in step 430 to be complete, results are displayed in step 240, however when the batch is determined in step 430 to not be complete and it is further determined in step 435 that there are no more results, then current results are displayed in step 240 to the client system. When it is determined in step 435 that there are more results, then the next link in step 440 is to be determined for availability and the previous steps are repeated until a batch of results is completed in step 430 or there are no more results in step 435. In effect, all unavailable or dead links are filtered from the retrieval of search results before displayed to the client system assuring that all displayed hyperlinks are available.

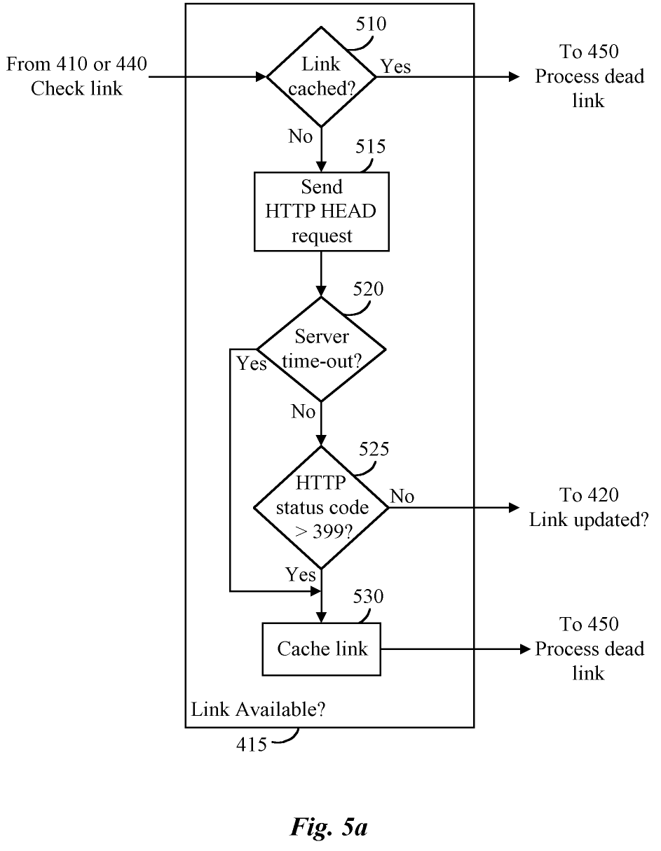

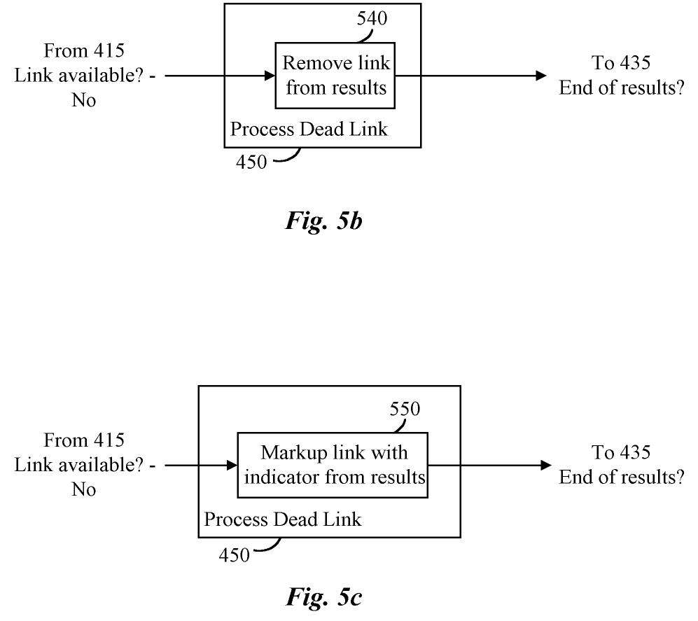

Fig. 5a is a flowchart illustrating one way to determine link availability (step 415). When availability of a link is determined, the URL of the link is compared in step 510 to a link cache 178. The link cache 178 is configured by storing unavailable or dead links 182, in an effort to minimize cache size (other cache configurations will be discussed). When the link is determined in step 510 to be cached, then the dead link is processed in step 450. However, when the link is determined in step 510 to not be cached, then a HTTP HEAD (OR GET) REQUEST is sent in step 515 to the server corresponding to the URL of the link. If the server times-out in step 520 and there are no server responses or when the server returns in step 525 a HTTP status code > "399", then the network resource corresponding to the link can not be located and the link or resource identifier can be stored in step 530 in the link cache 178. When the link is cached 182, then the link is dead and processed in step 450. However, when the HTTP status code is less than "400" then the network resource can be located and the link is determined available and the link is updated in step 420.

Fig. 5b is a flowchart illustrating processing a link that is determined to be dead or unavailable (step 450). When the link is to be processed in step 450, then the link is removed in step 540 from results, and end of results may be determined in step 435.

Fig. 5c is a flowchart that illustrates another method of link processing (step 450). When the link is to be processed in step 450 then the link is marked up with a distinguishable indicator in step 550 from results and then end of results is determined in step 435. For instance the link may be displayed using distinguishable features such as fonts, character size, color, underlining, background attributes, reverse video, etc. As will be readily apparent to those skilled in the art, other distinguishing characteristics can be used without departing from the spirit and scope of the present invention.

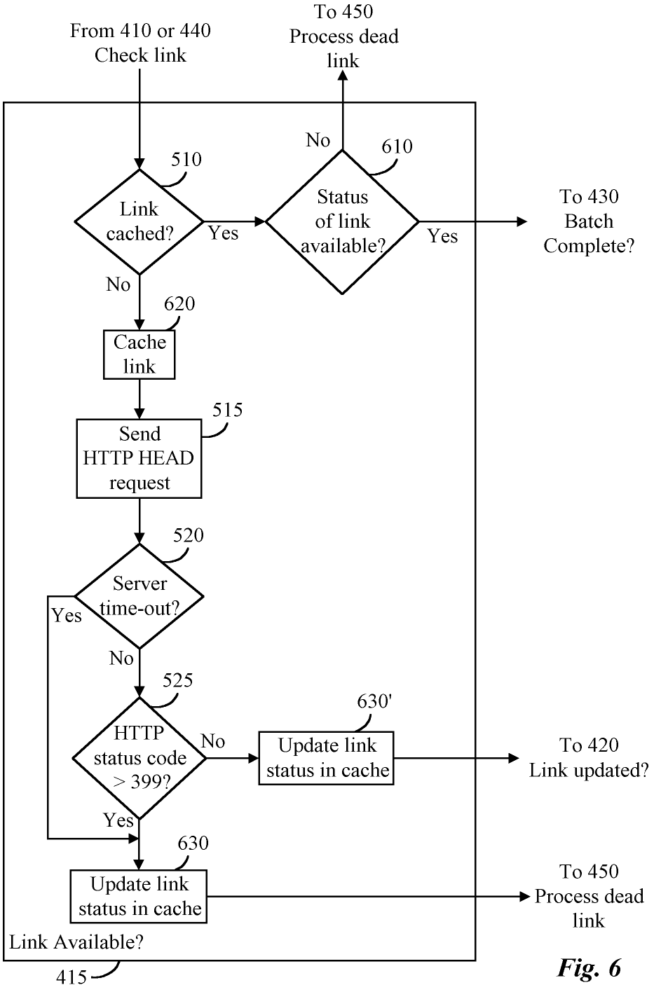

Fig. 6 illustrates how another cache configuration may be used to determine link availability (step 415). When availability of a link is determined, the URL of the link is compared in step 510 to a link cache 178. When the link is determined in step 510 to be cached 182, then it is determined in step 610 whether the status of the link is available. If the status is available, then it is determined in step 430 whether there is a complete batch, otherwise the link is processed in step 450. However, when it is determined in step 510 that the link is not cached 182, then the link is cached in step 620. After the link is cached 182, a HTTP HEAD (OR GET) REQUEST is sent in step 515 to the server corresponding to the URL of the link. If the server times-out in step 520 and there is no server response or when the server returns in step 525 a HTTP status code > "399" then the network resource corresponding to the link can not be located and the link or resource identifier status is cached 184 in step 630 and the link is processed in step 450. However, when the HTTP status code is less than "400" then the link status of available is cached 184 in step 630' and the available link is updated in step 420.

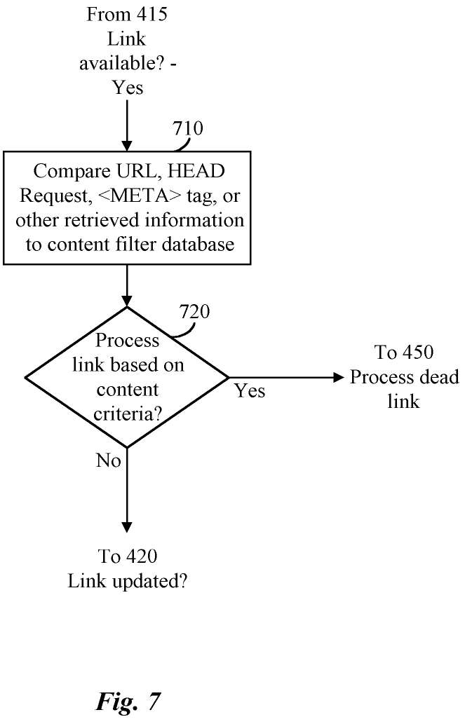

Fig. 7 illustrates how links can be filtered and processed based upon content criteria. After a link is determined in step 415 to be available, the step of content filtering may be performed by comparing in step 710 an identifier or any portion thereof (e.g., the parsed components of the link or URL such as a domain name, path, etc.), content from a HTTP HEAD Request, content from a retrieved <META> tag, or other retrieved information to a content filter database 176. A determination is made in step 720 as to whether to process the link based on content criteria as a result of step 710. When the link is to be processed, the link is then processed in step 450. However when the link is not to be processed, it may be further determined in step 420 whether the link is to be updated. Providing content filtering in real time assures that children are not exposed to adult content, for example. Links that access adult content may be removed from the search results.

A hit count 186, expiration time 188, or some combination of both may be utilized to maintain the link/resource identifier status cache (e.g., purging records). The link cache may be used for the purposes of minimizing network bandwidth. Results may be formatted such that at any time a user can input a new search request. Scheduling may be utilized to create both a buffer and queue to assure load balancing of client/server requests. The invention may be configured to determine link availability in parallel by threading or multitasking the filtering process. A robust system if necessary can be constructed to perform content updates through multiple servers in real time without delay or the use of scheduling. Further adaptations can be applied to those skilled in the art when the search request spans the retrieval of search results from multiple search engines.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a "means") used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

I claim:

Claims

1. A method comprising: generating search results having one or more resource identifiers; determining whether at least one network resource corresponding to said one or more resource identifiers can not be located; and, modifying said search results and providing said modified search results when it is determined that said at least one network resource corresponding to said one or more resource identifiers can not be located.

2. A method, as set forth in claim [c1], further including generating said search results from a search request.

3. A method, as set forth in claim [c2], wherein said generating said search results from said search request includes querying a search engine having a database.

4. A method, as set forth in claim [c2], further including inputting said search request from a user interface element.

5. A method, as set forth in claim [c4], wherein said inputting said search request from said user interface element further includes inputting said search request into one of a browser location field, text box, and command line.

6. A method as set forth in claim [c1], wherein said modifying said search results includes distinguishing within said search results all said resource identifiers corresponding to said all network resources that can be located from all said resource identifiers corresponding to all said network resources that can not be located.

7. A method as set forth in claim [c1], wherein said modifying said search results includes removing all said resource identifiers corresponding to all said network resources that can not be located.

8. A method, as set forth in claim [c1], wherein said modifying said search results includes one of a accessing and updating a resource identifier status cache.

9. A method as set forth in claim [c1], wherein said modifying said search results includes one of a including advertising with said modified search results and removing any duplicate resource identifiers from said modified search results.

10. A method as set forth in claim [c1], wherein said providing said modified search results includes displaying at least one distinguishable indicator corresponding to said at least one resource identifier.

11. A method as set forth in claim [c10], wherein said at least one distinguishable indicator is one of a font, size, color, and underline.

12. A method as set forth in claim [c1], wherein said providing said modified search results includes one of a displaying, notifying, and accessing said modified search results.

13. A method as set forth in claim [c1], wherein said determining whether said at least one network resource can not be located includes requesting a status code for each said resource identifier.

14. A method as set forth in claim [c1], wherein said determining whether said at least one network resource can not be located includes determining whether at least one corresponding resource identifier can not be resolved.

15. A method as set forth in claim [c1], wherein said determining whether said at least one network resource can not be located includes minimizing the amount of network bandwidth required to determine whether said at least one network resource can not be located.

16. A method, as set forth in claim [c1], wherein said determining whether said at least one network resource can not be located includes one of a accessing and updating a resource identifier status cache.

17. A method as set forth in claim [c1], further including one of an accessing and updating a resource identifier status cache after said generating said search results.

18. A method as set forth in claim [c1], further including one of an accessing and updating a resource identifier status cache after said determining whether said at least one network resource can not be located.

19. A method as set forth in claim [c1], wherein each said resource identifier is one of a uniform resource identifier, uniform resource locator, and hyperlink.

20. An apparatus comprising: means for generating search results having one or more resource identifiers; means for determining whether at least one network resource corresponding to said one or more resource identifiers can not be located; and, means for modifying said search results and providing said modified search results when it is determined that said at least one network resource corresponding to said one or more resource identifiers can not be located.

21. A computer program product comprising computer readable program code stored on a computer readable medium, the program code adapted to execute the method for generating search results having one or more resource identifiers, determining whether at least one network resource corresponding to said one or more resource identifiers can not be located, and modifying said search results and providing said modified search results when it is determined that said at least one network resource corresponding to said one or more resource identifiers can not be located.

22. A method comprising: generating search results having one or more hyperlinks; determining whether at least one hyperlink of said one or more hyperlinks is dead; and, modifying said search results and providing said modified search results when it is determined that said at least one hyperlink of said one or more hyperlinks is dead.
